(19) United States
(12) Patent Application Publication
(10) Pub. No.: US 2026/0110400 A1
(43) Pub. Date: Apr. 23, 2026

(54) METHOD FOR MANUFACTURING LINER FOR PRESSURE VESSEL AND LINER FOR PRESSURE VESSEL

(71) Applicant: TOYOTA JIDOSHA KABUSHIKI KAISHA, Toyota-shi (JP)

(72) Inventor: Youjirou IRIYAMA, Toyota-shi (JP)

(73) Assignee: TOYOTA JIDOSHA KABUSHIKI KAISHA, Toyota-shi (JP)

(21) Appl. No.: 19/252,434

(22) Filed: Jun. 27, 2025

(30) Foreign Application Priority Data
Oct. 18, 2024 (JP) 2024-183598

(51) Int. Cl. F17C 1/16; B29C 48/00; B29C 48/09; B29L 31/00

(52) U.S. Cl. CPC F17C 1/16; B29C 48/0017; B29C 48/09; B29L 2031/7156; F17C 2203/0604; F17C 2203/0673; F17C 2209/2109; F17C 2209/232; F17C 2221/012; F17C 2221/016; F17C 2221/017; F17C 2221/033

(57) ABSTRACT

A liner for a pressure vessel includes body portions each including a central portion and tapered portions, and a plurality of connecting portions each connecting two of the body portions adjacent to each other in series via the tapered portions, having a smaller diameter than the central portion, and bent to fold the body portions. The method includes a step of manufacturing the liner by extruding a tubular preform having a predetermined bore diameter, disposing a tubular molding assist member having an outside diameter corresponding to a bore diameter of the connecting portion on an inside of a portion of the preform corresponding to the connecting portion, and performing blow molding with the molding assist member in contact with the inside of the connecting portion.

### CROSS-REFERENCE TO RELATED APPLICATION

This application claims priority to Japanese Patent Application No. 2024-183598 filed on Oct. 18, 2024. The disclosure of the above-identified application, including the specification, drawings, and claims, is incorporated by reference herein in its entirety.

### BACKGROUND

### 1. Technical Field

The technology disclosed in the present specification relates to a method for manufacturing a liner for a pressure vessel, and to a liner for a pressure vessel.

### 2. Description of Related Art

Hitherto, a pressure vessel for storing a fluid is known. The pressure vessel has a structure in which a liner alternately includes body portions each having a tubular shape and connecting portions each having a similar tubular shape and having a smaller diameter than the body portion (FIG. 5c etc. of Japanese Unexamined Patent Application Publication (Translation of PCT Application) No. 2018-519480 (JP 2018-519480 A)). This type of liner before bending may be manufactured, for example, by continuously performing, using a pair of rotary mold sets, blow molding on an extruded tubular body into body portions and small-diameter connecting portions. This method is advantageous in that the body portions and the connecting portions of the liner can be molded continuously at a time. Then, the liner is bent at the connecting portions to fold the body portions, thereby obtaining a folded pressure vessel.

### SUMMARY

In this liner, the tubular body having a constant thickness is continuously molded into the large-diameter body portions and the small-diameter connecting portions. Therefore, the thickness of the small-diameter connecting portion tends to be larger than that of the body portion. Further, the thickness of the connecting portion may be uneven.

In such cases, the bending of the liner may be difficult because of difficulty in applying a uniform load at the connecting portion due to the increase or unevenness in thickness. This may lead to a decrease in production efficiency in the bending or difficulty in obtaining a uniform shape of the connecting portion.

The present specification provides a technology for continuously molding a liner for a pressure vessel that is easily bent.

The present specification is embodied in a method for manufacturing a liner for a pressure vessel. The liner includes body portions each including a central portion and tapered portions, and a plurality of connecting portions each connecting two of the body portions adjacent to each other in series via the tapered portions, having a smaller diameter than the central portion, and bent to fold the body portions. The method includes a step of manufacturing the liner by extruding a tubular preform having a predetermined bore diameter, disposing a tubular molding assist member having an outside diameter corresponding to a bore diameter of the connecting portion on an inside of a portion of the preform corresponding to the connecting portion, and performing blow molding with the molding assist member in contact with the inside of the connecting portion.

With this method for manufacturing the liner, the connecting portion is molded to have a desired and uniform thickness by bringing the molding assist member in contact with the inside of the portion corresponding to the connecting portion. Therefore, the connecting portion having the intended thickness, bore diameter, and shape can be obtained. As a result, bending can easily be performed at the connecting portion of the liner.

In another aspect of this manufacturing method, the step may include using a mold set including a plurality of pairs of molds disposed to face the preform on a predetermined track. Thus, the liner can be manufactured efficiently.

In another aspect of this manufacturing method, the step may include molding the connecting portion to provide a groove shape on an outer surface to be located on an inside when the connecting portion is bent. Thus, it is possible to manufacture the liner including the connecting portions that can be bent more easily.

In another aspect of this manufacturing method, the method may further include a step of bending the connecting portions of the liner to fold the body portions.

The present specification is also embodied in a liner for a pressure vessel. The liner includes body portions each including a central portion and tapered portions, and a plurality of connecting portions each connecting two of the body portions adjacent to each other in series via the tapered portions, having a smaller diameter than the central portion, and bent to fold the body portions. The connecting portion includes a thick portion between the connecting portion and at least one of the tapered portions adjacent to the connecting portion.

This liner includes the thick portion at the end of the connecting portion close to the tapered portion. Therefore, an increase in thickness at the connecting portion is suppressed and the bending at the connecting portion is facilitated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an overview of a process for manufacturing a liner for a pressure vessel;

FIG. 2 is a diagram showing an example of a molding apparatus;

FIG. 3 is a diagram showing a state of a connecting portion of the liner during molding; and

FIG. 4 is a diagram showing a state during molding in which a groove shape is provided to the connecting portion.

### DETAILED DESCRIPTION OF EMBODIMENTS

Hereinafter, a method for manufacturing a liner for a pressure vessel, etc. disclosed in the present specification will be described with reference to the drawings as appropriate. The fluid to be stored in the pressure vessel is not particularly limited in the present specification, and may be, for example, hydrogen, natural gas, helium, dimethyl ether, liquefied petroleum gas, or xenon.

The pressure vessel is generally formed by folding a braided body of a fiber-reinforced plastic material such as CFRP on the surface of a liner 100 into a predetermined shape. The braided body is, for example, integrated with the surface of the liner 100 before or simultaneously with bending of the liner 100, or with the surface of a liner 110 after the bending. For convenience of the following description, the braided body will be omitted.

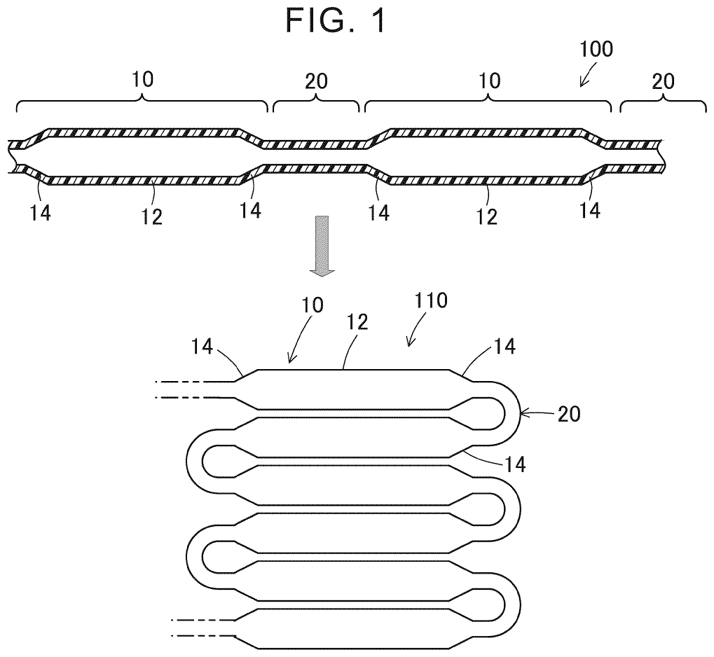

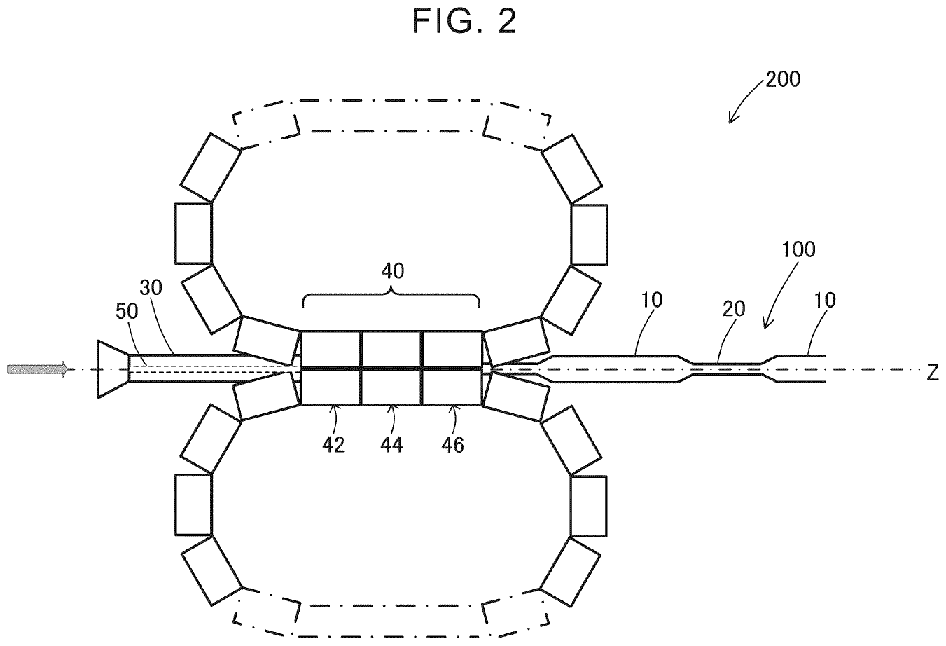

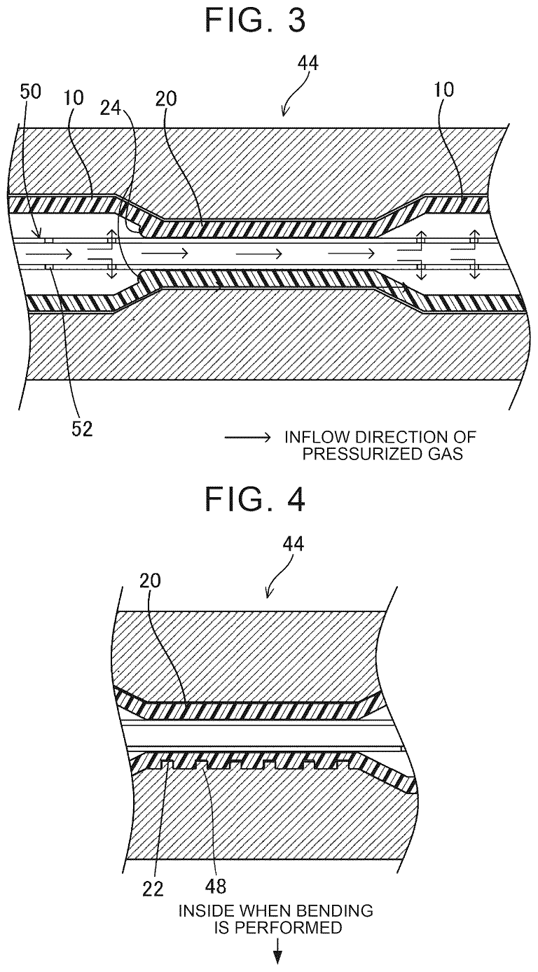

The upper portion of FIG. 1 shows part of the liner 100 for the pressure vessel before the bending, and the lower portion of FIG. 1 shows the liner 110 after the bending. FIG. 2 shows an example of a molding apparatus 200. FIG. 3 shows a cross section during molding of a connecting portion 20. FIG. 4 shows a cross section during molding in which a groove shape is provided to the surface of the connecting portion 20. In FIGS. 2 to 4, a preform 30 moves from the left to the right in the drawings. First, an overview of the liner 100 will be described, and then the method for manufacturing the liner 100 will be described.

As shown in the upper portion of FIG. 1, the liner 100 has a shape in which a plurality of body portions 10 and a plurality of connecting portions 20 are alternately arranged in series. The body portion 10 includes a central portion 12 and tapered portions 14. The central portion 12 has a tubular shape that extends with a predetermined diameter. The tapered portion 14 has a tapered shape in which the diameter gradually decreases from the central portion 12 and matches the diameter of the connecting portion 20.

The connecting portion 20 has a tubular shape with a smaller diameter than that of the central portion 12. The connecting portion 20 connects adjacent body portions 10 via the tapered portions 14. The connecting portion 20 is configured to be bent such that the body portions 10 can be folded. By adopting the shape in which the body portions 10 and the connecting portions 20 are alternately connected in series, the folded liner 110 shown in the lower portion of FIG. 1 can be obtained.

The liner 100 is molded by performing, using a mold having molding surfaces corresponding to the body portions 10 and the connecting portions 20, blow molding on a tubular preform (parison) obtained by extruding a resin material having a predetermined composition. The liner 100 is formed into an elongated body because it is to be folded. For this reason, it is preferable that the liner 100 be molded continuously and integrally by continuous blow molding.

It is particularly preferable to perform blow molding using the molding apparatus 200 including a mold set 40 on a predetermined track Z as shown in FIG. 2. With the molding apparatus 200, the body portions 10 and the connecting portions 20 can be molded alternately and continuously from the preform 30 by moving the mold set 40 in coordination with the extrusion of the preform 30. The mold set 40 includes pairs of molds 42, 44, 46 disposed to face the extruded preform 30. The mold set 40 is configured to mold a unit structure including at least one body portion 10 and at least one connecting portion 20. The molding apparatus 200 also includes an extruder (not shown) that extrudes the preform 30 into the mold set 40.

In the molding apparatus 200, a molding assist member 50 is disposed from the vicinity of the extrusion port of the preform 30 to the inside of the preform 30 along the extrusion direction of the preform 30. The molding assist member 50 has a length substantially equal to that of the range in which the molds 42, 44, 46 of the mold set 40 are disposed. The molding assist member 50 is, for example, a metal pipe.

As shown in FIG. 3, the molding assist member 50 has a plurality of air holes 52 through which pressurized gas is blown into the inside of the preform 30 via the hollow portion of the molding assist member 50. Thus, the pressurized gas can be supplied uniformly into the preform 30.

The outside diameter of the molding assist member 50 is set such that the connecting portion 20 has an intended thickness by the molding surfaces of the molds 42, 44, 46 constituting the mold set 40 and the outer surface of the molding assist member 50.

The outer shape of the molding assist member 50 is not particularly limited, and may be, for example, a circular, elliptical, or quadrangular shape. The shape of the connecting portion 20 is determined by the outer shape of the molding assist member 50.

To mold the liner 100, a resin material having a predetermined composition is first melted and extruded to mold the preform 30. The resin material of the liner 100 is not particularly limited, and may be, for example, one kind or two or more kinds of resin material selected from among polyamide (PA), ethylene vinyl alcohol (EVOH), high-density polyethylene (HDPE), ethylene vinyl acetate (EVA), and linear low-density polyethylene (LLDPE). The liner 100 may have a single-layer structure or a multi-layer structure of two or more layers using these resin materials. In consideration of bending, an elastomer material such as rubber may be included.

As shown in FIG. 3, the continuously extruded preform 30 enters the track Z where the mold set 40 is disposed to face the preform 30, and the molds 42 etc. are gradually closed. Simultaneously with the closing, pressurized gas is blown into the inside of the preform 30 via the molding assist member 50.

Since the molding assist member 50 is disposed inside the preform 30, at the molding portion for the connecting portion 20 on the preform 30, the mold set 40 is closed with the molding assist member 50 in contact with the molding surface for the connecting portion 20 in the mold set 40. Therefore, the connecting portion 20 is molded in a manner similar to press forming. As a result, the connecting portion 20 can be molded into the intended thickness and shape. As the preform 30 moves along the extrusion direction, the molding portion for the connecting portion 20 on the preform 30 is brought into contact at least once with the molding assist member 50. Therefore, the connecting portion 20 is molded in a manner similar to press forming. The connecting portion 20 is once press-formed by the molding assist member 50 and the molding portion for the connecting portion 20 in the mold set 40. As the preform 30 moves on the track Z, the molding portion for the connecting portion 20 moves away from the molding assist member 50. While not in contact with the molding assist member 50, the molding portion is molded by the pressurized gas.

When the connecting portion 20 is molded by the molding assist member 50 and the molding surface of the mold set 40 in a manner similar to press forming, an excess resin material may move to the tapered portion 14. As a result, a thick portion 24 may be formed between the connecting portion 20 and the adjacent tapered portion 14. The thick portion 24 is thick over the entire inner circumference or part of it at the end of the connecting portion 20 close to the tapered portion 14. The thick portion 24 ensures the thickness and shape of the connecting portion 20 intended by the molding assist member 50. For example, the thick portion 24 may be formed between the connecting portion 20 and the tapered portion 14 located rearward of the connecting portion 20 in the extrusion direction. Further, the thick portions 24 may be formed between the connecting portion 20 and both of the two adjacent tapered portions 14.

As shown in FIG. 4, the molding surface of the mold set 40 that molds the connecting portion 20 can include a protruding molding portion 48 that can provide a groove portion 22 to the outer surface that corresponds to the inside when the connecting portion 20 is bent. Thus, it is possible to further facilitate the bending of the connecting portion 20.

The pressurized gas is supplied by the molding assist member 50 to the molding portion for the body portion 10 on the preform 30. Thus, blow molding is performed to form the body portion 10 defined by the molding surface of the mold set 40.

When the preform 30 is molded into the intended shape by the mold set 40, the mold set 40 is opened and the liner 100 alternating including the body portions 10 and the connecting portions 20 is ejected onto the track Z.

The obtained liner 100 has the intended thickness at the connecting portion 20 without the increase or unevenness in thickness. Further, the connecting portion 20 has the intended shape. As a result, when the liner 100 is bent in a subsequent step to obtain the liner 110, the bending is facilitated. Thus, the bending can be performed with excellent production efficiency and without any shape defects.

In the above embodiment, the molding assist member 50 extends over the length of the mold set 40, but this case is not limitative. The molding assist member 50 may be provided in a range from the vicinity of the extrusion port of the preform 30 to a position where the molding assist member 50 reaches the molding portion for the first connecting portion 20. Even in this case, the connecting portion 20 is once press-formed by the molding assist member 50. Therefore, the intended thickness and shape can be obtained easily and the bending of the connecting portion 20 can be facilitated.

In the above embodiment, the molding apparatus 200 performs the blow molding using the pressurized gas, but may perform vacuum molding. In the above embodiment, the groove portion 22 is provided on the inner portion of the connecting portion 20 when it is bent, but this case is not limitative. The outer portion of the connecting portion 20 when it is bent may also have a curved or bent shape to facilitate the bending. In this case, it is necessary to provide predetermined shapes to both the mold set 40 and the molding assist member 50.

In the above embodiment, the liner 100 and the liner 110 after the bending have been described, but the present specification also provides a pressure vessel including the liner 100, 110 and a method for manufacturing the pressure vessel. The structure of the pressure vessel for storing a fluid such as hydrogen using the liner 100, 110 and the manufacturing method are known to those skilled in the art.

The present specification includes the following configurations.
[1] A method for manufacturing a liner for a pressure vessel,
the liner including body portions each including a central portion and tapered portions, and a plurality of connecting portions each connecting two of the body portions adjacent to each other in series via the tapered portions, having a smaller diameter than the central portion, and bent to fold the body portions,
the method including a step of manufacturing the liner by extruding a tubular preform having a predetermined bore diameter, disposing a tubular molding assist member having an outside diameter corresponding to a bore diameter of the connecting portion on an inside of a portion of the preform corresponding to the connecting portion, and performing blow molding with the molding assist member in contact with the inside of the connecting portion.
[2] The method according to [1], in which the step includes using a mold set including a plurality of pairs of molds disposed to face the preform on a predetermined track.
[3] The method according to [1] or [2], in which the step includes molding the connecting portion to provide a groove shape on an outer surface to be located on an inside when the connecting portion is bent.
[4] The method according to any one of [1] to [3], further including a step of bending the connecting portions of the liner.
[5] A liner for a pressure vessel, the liner including body portions each including a central portion and tapered portions, and a plurality of connecting portions each connecting two of the body portions adjacent to each other in series via the tapered portions, having a smaller diameter than the central portion, and bent to fold the body portions, in which
the connecting portion includes a thick portion between the connecting portion and at least one of the tapered portions adjacent to the connecting portion.

The technical elements described herein or illustrated in the drawings exhibit technical utility solely or in various combinations, and are not limited to the combination described in the claims as filed. The technologies described herein or illustrated in the drawings may simultaneously achieve a plurality of objects, and exhibit technical utility by achieving one of the objects.

What is claimed is:

1. A method for manufacturing a liner for a pressure vessel, the liner including body portions each including a central portion and tapered portions, and a plurality of connecting portions each connecting two of the body portions adjacent to each other in series via the tapered portions, having a smaller diameter than the central portion, and bent to fold the body portions, the method comprising a step of manufacturing the liner by extruding a tubular preform having a predetermined bore diameter, disposing a tubular molding assist member having an outside diameter corresponding to a bore diameter of the connecting portion on an inside of a portion of the preform corresponding to the connecting portion, and performing blow molding with the molding assist member in contact with the inside of the connecting portion.

2. The method according to claim 1, wherein the step includes using a mold set including a plurality of pairs of molds disposed to face the preform on a predetermined track.

3. The method according to claim 1, wherein the step includes molding the connecting portion to provide a groove shape on an outer surface to be located on an inside when the connecting portion is bent.

4. The method according to claim 1, further comprising a step of bending the connecting portions of the liner.

5. A liner for a pressure vessel, the liner comprising body portions each including a central portion and tapered portions, and a plurality of connecting portions each connecting two of the body portions adjacent to each other in series via the tapered portions, having a smaller diameter than the central portion, and bent to fold the body portions, wherein the connecting portion includes a thick portion between the connecting portion and at least one of the tapered portions adjacent to the connecting portion.
